(19) United States
(12) Patent Application Publication
(10) Pub. No.: US 2003/0112752 A1
(43) Pub. Date: Jun. 19, 2003

(54) System and method for controlling congestion in networks

(76) Inventors: Kazuyuki Irifune, Fujisawa (JP); Katsuyuki Tsunami, Yokohama (JP); Takashi Nishikado, Ebina (JP); Hideo Aoki, Yokohama (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/147,878

(22) Filed: May 20, 2002

(30) Foreign Application Priority Data
Dec. 13, 2001 (JP) 2001-379772

(51) Int. Cl. H04J 1/16

(52) U.S. Cl. 370/229

(57) ABSTRACT

A congestion controlling device is connected to client terminals and contents servers via communications lines. When a load distributing device receives requests from the client terminals that have made the requests for acquisitions of the information, the load distributing device judges whether the situation of the relay processing has satisfied a predetermined condition. If the situation has satisfied the condition, not only the client's requests are regulated, but predetermined messages of either reasons for the regulation or requests to defer the client's requests for a while are notified to the client terminals. The congestion controlling device may include Web proxy servers each including a cache. If the information requested by the client terminals has been stored in the cache of the Web proxy server, the information in the cache is transmitted to the client terminals.

### BACKGROUND OF THE INVENTION

The present invention relates to a congestion controlling system in data communications among client terminals and servers. The present invention employs, as its targets, the data communications performed in, for example, a communications carrier, an ISP (Internet Service Provider), and an intra-firm network (e.g., Local Area Network: LAN, Wide Area Network: WAN).

Nowadays, the client terminals that are connectable to the Internet are being rapidly prevailing. This condition has made it possible from the client terminals to execute, via the Internet, browsing of news, weather forecast, or local-region information, ticket reservation, bank transaction, securities exchange, and the like. Also, in addition to the accesses from PCs (personal computers), the cases where the accesses are made from mobile phones so as to enjoy the above-described services have increased in number.

In this way, the execution of the various types of services has been made possible via the communications lines. This condition makes it likely that the service requests will be concentrated on a particular server. The scheme that the client terminals directly make the service requests to the server has caused the following situation to occur: With respect to the large number of the requests from the client terminals, the communications-lines capacities and the processing capabilities of the server cannot deal with the requests, and accordingly the responses become more or less unlikely to be returned back to the users.

For example, in a network system that includes, as its targets, several millions or more users, in some cases, the requests are concentrated on a particular URL (Uniform Resource Locator). On that occasion, there exist many cases where the communications paths come to be congested (which means that the communications paths are jammed and the communications become impossible), or where the loads are concentrated on the data relaying devices and the contents severs. As a result, the users are kept waiting for a long time until the users can enjoy the services, or cannot utilize necessary services at all.

Also, the excessive loads are concentrated on the data relaying devices and the contents severs. This condition may cause some troubles to occur therein and stop the operations, thereby resulting in a possibility of stopping even the function as the entire network. Moreover, if the service degradations to the users occur frequently due to the concentration of the requests, there exits a possibility that a user who now utilizes the network system may transfer to the network system of another firm. In addition, influences to the communications carrier or the ISP business that provides the network system can also be anticipated. The control over the congestion like this has been disclosed in, for example, U.S. Pat. No. 5,335,224.

Also, as the case where a service request cannot be accepted, there exists the following case: A request for particular contents from a user, e.g., a request for the contents including violence or a content contrary to the public peace and good order, is regulated so that the particular contents will not be provided to the user. In such a case, the user cannot know the reason why the user cannot receive the requested contents.

### SUMMARY OF THE INVENTION

It is an object of the present invention to provide a congestion controlling system for allowing a user to effectively utilize a service.

It is another object of the present invention to provide a congestion controlling system for allowing the user to know the situation of a service even if the response to the service request made from the user is slow.

According to one point-of-view of the present invention, there is provided a congestion controlling system including a plurality of client terminals capable of making requests for acquisitions of information and displaying the information acquired in response to the requests, a plurality of contents servers for making responses to the requests so as to transmit, to the plurality of client terminals, the information corresponding to the requests, and a congestion controlling device set up between the plurality of client terminals and the plurality of contents servers, wherein the congestion controlling device includes the following configuration components: A data relaying device made related with the plurality of client terminals and the plurality of contents servers for performing the relay there between, a plurality of Web proxy servers including a unit for caching particular information when a request for acquiring the particular information occurs a plurality of times and a unit for transmitting the particular information to the plurality of client terminals, a load distributing device made related with the data relaying device and the Web proxy servers for performing a distributing control over the requests from the data relaying device so that the requests will not be concentrated on a particular Web proxy server, and a request regulating unit made related with the load distributing device for regulating the requests from the client terminals.

In the case where a large number of requests have been made from the client terminals, the use of the above-described congestion controlling system makes it possible to suppress the congestion in the communications system.

The utilization of the present invention allows a communications system provider to provide the users with the higher-reliability communications services in comparison with the conventional ones. The users can enjoy the communications services that, in answer to the requests, permit the users to obtain higher-speed responses than the conventional ones. Also, in the case where the requests are excessive in number, the communications system informs the users that the system cannot accept the requests from the users. This makes it unnecessary for the users to waiting for the responses for a long time, thereby permitting the users to request some other services. The communications system provider can have chances for providing the new services.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram for illustrating the configuration of a congestion controlling system according to one embodiment of the present invention;

FIG. 2A is a diagram for illustrating the configuration of a load distributing device and FIG. 2B is a diagram for illustrating the configuration of a Web proxy server inside the congestion controlling system according to the embodiment of the present invention;

FIG. 3 is a diagram for illustrating the configuration of a request regulating device inside the congestion controlling system according to the embodiment of the present invention;

FIG. 4 is a flowchart diagram for showing a congestion control method where the number of unprocessed-requests is defined and employed as the judgement criterion in the congestion controlling system according to the embodiment of the present invention;

FIG. 5 is a sequence diagram for showing the congestion control method where the number of the unprocessed-requests is defined and employed as the judgement criterion in the congestion controlling system according to the embodiment of the present invention;

FIG. 6 is a diagram concerning a method of judging whether or not the number of the unprocessed-requests exceeds a threshold value in the congestion controlling system according to the embodiment of the present invention;

FIG. 7 is a diagram concerning another method of judging whether or not the number of the unprocessed-requests exceeds threshold values in the congestion controlling system according to the embodiment of the present invention;

FIG. 8A is a diagram for illustrating an example of a regulating message content, and FIG. 8B is a diagram for illustrating a description example of regulating contents;

FIG. 9 is a flowchart diagram for showing a congestion control method where a requested URL is defined and employed as the judgement criterion in a congestion controlling system according to a 1st modified example of the embodiment of the present invention;

FIG. 10 is a diagram for illustrating an example of regulated request contents and the target URLs according to the 1st modified example of the embodiment of the present invention;

FIG. 11A is a diagram for illustrating an example of the regulating message content, and FIG. 11B is a diagram for illustrating a description example of the regulating contents according to the 1st modified example of the embodiment of the present invention;

FIG. 12 is a flowchart diagram for showing a congestion control method where the performance of the Web proxy server is defined and employed as the judgement criterion in a congestion controlling system according to a 2nd modified example of the embodiment of the present invention;

FIG. 13 is a flowchart diagram for showing a congestion control method where the response time of the contents server is defined and employed as the judgement criterion in a congestion controlling system according to a 3rd modified example of the embodiment of the present invention;

FIG. 14 is a flowchart diagram for showing a congestion control method where the line utilization ratio is defined and employed as the judgement criterion in a congestion controlling system according to a 4th modified example of the embodiment of the present invention;

FIG. 15A is a diagram for illustrating an example of the regulating message content, and FIG. 15B is a diagram for illustrating a description example of the regulating contents; and

FIG. 16 is a diagram for illustrating the contents of a statistical information processing set up in a system managing device or outside the system managing device.

### DESCRIPTION OF THE EMBODIMENTS

In the present specification, the client terminals are, for example, terminals that are capable of requesting, via the Internet, information such as characters, images, sounds, or the like and displaying the requested information with the characters, the images, the sounds, or the like. The contents servers are, for example, servers for receiving the requests so as to transmit, to the client terminals, the information corresponding to the requests. The Web proxy servers are, for example, servers including a unit for transmitting information to the client terminals without transmitting the requests from the congestion controlling system to the contents servers.

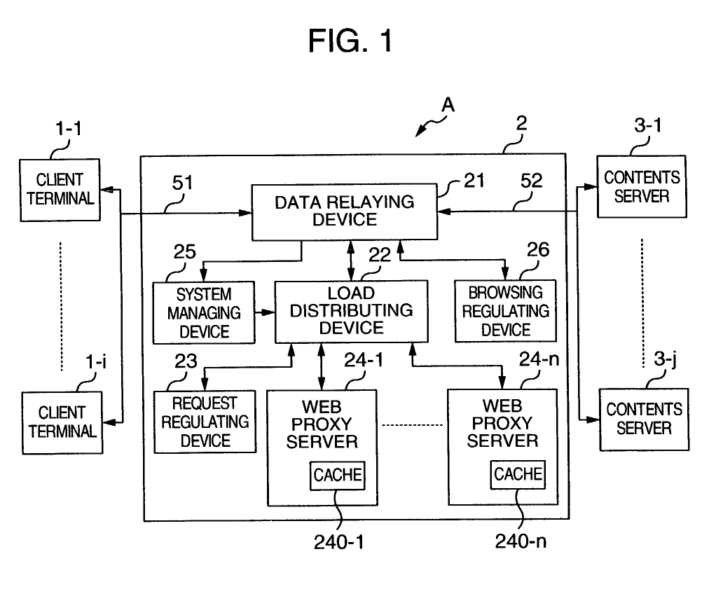

Hereinafter, referring to the FIGS. 1 to 6, the explanation will be given below concerning the congestion controlling system according to one embodiment of the present invention.

As illustrated in FIG. 1, the congestion controlling system A according to the embodiment of the present invention includes a large number of client terminals 1-1 to 1-i, a plurality of contents servers 3-1 to 3-j, and a congestion controlling device 2.

The client terminals 1-1 to 1-i are, for example, terminals that are capable of requesting, via the Internet, information such as characters, images, sounds, or the like and displaying (i.e., browsing) the requested information with the characters, the images, the sounds, or the like when acquiring these pieces of information. The client terminals 1-1 to 1-i are, for example, personal computers (PCs), personal digital assistants (PDAs), or mobile phones.

The plurality of contents servers 3-1 to 3-j, which are service offering parties, receive the requests from the client terminals 1-1 to 1-i, then transmitting the contents thereto. The congestion controlling device 2 is made related with each of the client terminals 1-1 to 1-i and each of the contents servers 3-1 to 3-j.

A provider (i.e., communications carrier) mediates between the client terminals 1-1 to 1-i and the plurality of contents servers 3-1 to 3-j. For example, the congestion controlling device (system) 2 has been set up as a piece of equipment included in the provider.

When the congestion occurs in the communications units and the network, the congestion controlling device 2 controls the congestion. The congestion controlling device 2 includes, for example, a data relaying device 21, a load distributing device 22, a request regulating device (server) 23, Web proxy servers 24-1 to 24-n, a system managing device 25, and a browsing regulating device 26. The congestion controlling device 2, in particular, distributes each of the requests from the client terminals 1-1 to 1-i into any one of the Web proxy servers 24-1 to 24-n, thereby making it possible to control a congestion that is caused by an increase in the utilization ratio of a communications line (52) between the data relaying device 21 and the contents servers 3-1 to 3-j.

The data relaying device 21, which is referred to as, e.g., “a router”, is a relaying device for transmitting/receiving the data between the client terminals 1-1 to 1-i and the contents servers 3-1 to 3-j. Namely, the device 21 transfers a transmission/reception data packet to a device of an address described in the header of the data packet.

As described above, the load distributing device 22 is, for example, a device for distributing a processing for each of the requests from the plurality of client terminals 1-1 to 1-i into any one of the plurality of Web proxy servers 24-1 to 24-n so as to distribute the load imposed onto the relaying device 21. Having received the header of a transmission/reception packet and a Web-contents acquiring request via the load distributing device 22, each of the Web proxy servers relays the request over to any one of the contents servers 3-1 to 3-j. Moreover, each of the Web proxy servers relays the contents transferred from any one of the contents servers 3-1 to 3-j, thereby transmitting the contents to the client terminal of the request source via the load distributing device 22 and any one of the Web proxy servers.

The request regulating device 23 is, for example, a device that, if a large quantity of Web contents acquiring requests have been concentrated from the client terminals for a short time-period, regulates the request quantity from the client terminals 1-1 to 1-i so that the request quantity will not exceed a processing limit of the Web proxy servers 24-1 to 24-n and the contents servers 3-1 to 3-j.

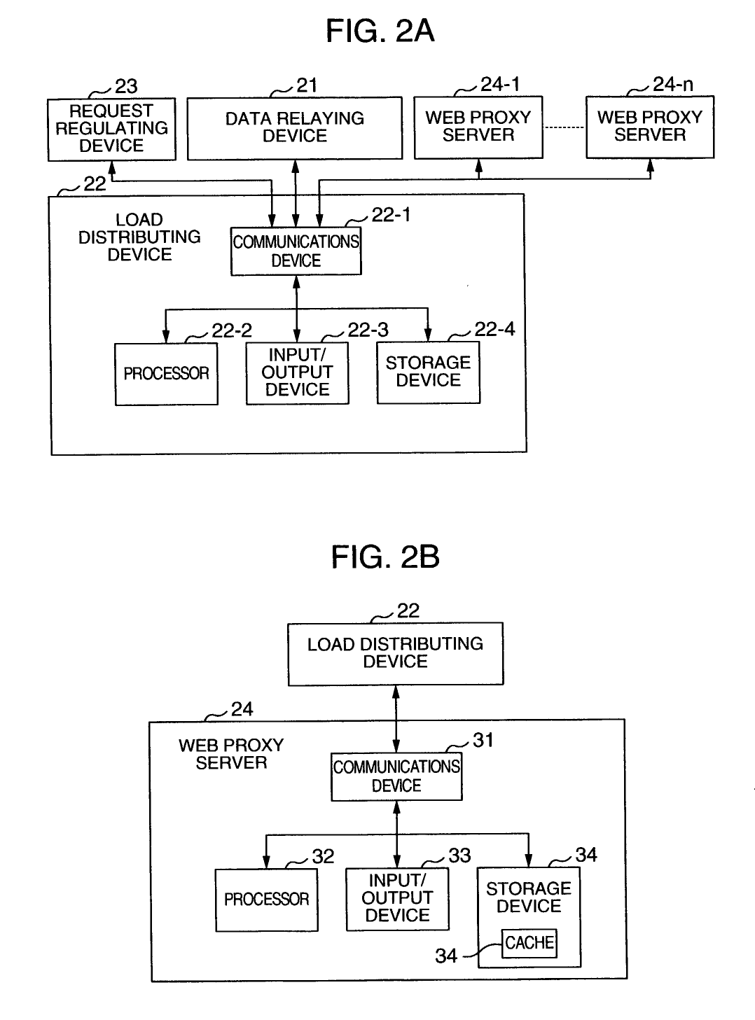

FIG. 2A is a function block diagram for illustrating the configuration of the load distributing device 22. As illustrated in FIG. 2A, the load distributing device 22 includes, for example, a communications device 22-1, a processor 22-2, an input/output device 22-3, and a storage device 22-4. The communications device 22-1 performs the transmission/reception of the data packets with the data relaying device 21 and the Web proxy server 24. The processor 22-2 performs the control of the entire device. The input/output device 22-3 includes, for example, a keyboard and a printer, thereby performing the data input/output for performing a control, an instruction, or the like. The storage device 22-4 stores various type of information.

FIG. 2B is a function block diagram for illustrating the configuration of an arbitrary Web proxy server of the Web proxy servers 24-1 to 24-n. Hereinafter, it is assumed that a reference numeral without a suffix denotes one of a plurality of identical or equivalent configuration components. As illustrated in FIG. 2B, the Web proxy server 24 includes, for example, a communications device 31, a processor 32, an input/output device 33, and a storage device 34. The communications device 31 performs the transmission/reception of the data packets with the load distributing device 22. The processor 32 performs the control of the entire device. The input/output device 33 includes, for example, a keyboard and a printer, thereby performing the data input/output for performing a control, an instruction, or the like. The storage device 34, which stores various type of information, includes a cache memory 240 for caching the contents information in the contents servers.

Incidentally, the load distributing device 22 has information indicating what contents which of the Web proxy servers 24-1 to 24-n has cached. The information stored temporarily into the cache is transmitted to the client terminal 1 from the Web proxy server 24 via the load distributing device 22.

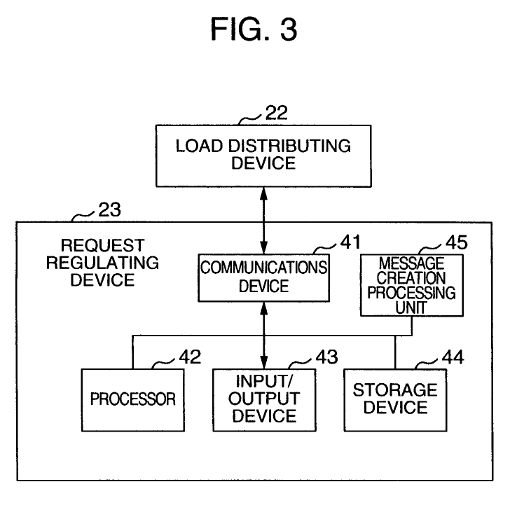

FIG. 3 is a function block diagram for illustrating the configuration of the request regulating device 23. The request regulating device 23 includes, for example, a communications device 41, a processor 42, an input/output device 43, a storage device 44, and a message creation processing unit 45. The communications device 41 performs the transmission/reception of the data packets with the load distributing device 22. The processor 42 performs the control of the entire device. The input/output device 43 includes, for example, a keyboard and a printer, thereby performing the data input/output for performing a control, an instruction, or the like. The storage device 44 stores various type of information. The message creation processing unit 45 will be explained later.

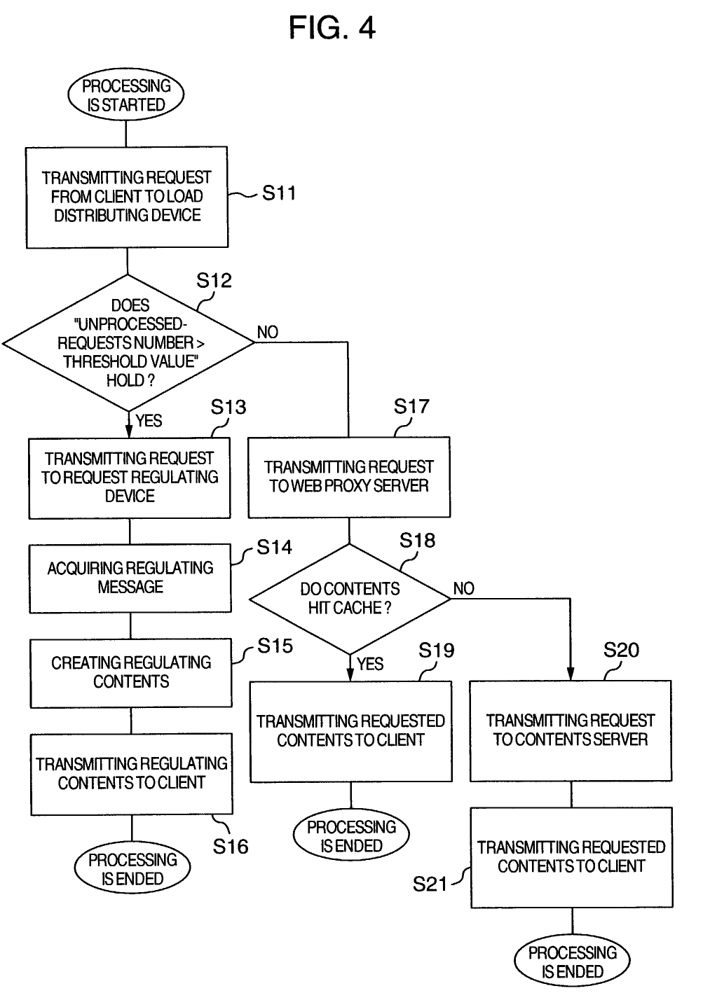

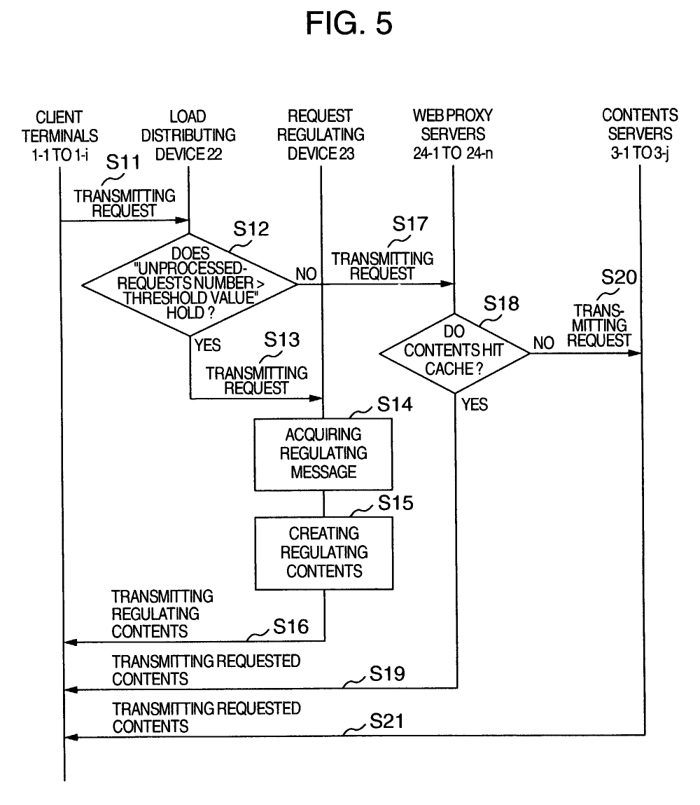

FIG. 4 is a flowchart diagram for showing a congestion control method where the number of unprocessed-requests is defined and employed as the judgement criterion. FIG. 5 is a sequence diagram for showing the congestion control method, where the processing flow in FIG. 4 is expressed as the data flow among the devices constituting the congestion controlling device 2. Although the explanation will be given below assuming that any one of all the client terminals 1-1 to 1-i has made the request, the processing flow also becomes basically the same in the case of assuming that any one of some terminals of the client terminals 1-1 to 1-i has made the request.

As illustrated in FIG. 4 and FIG. 5, if a client terminal 1 has transmitted a Web-contents acquiring request to a contents server 3, at a step S11, the request is sent to the load distributing device 22. At a step S12, the load distributing device 22 judges whether or not the above-described unprocessed-requests number has exceeded a threshold value set in advance. Here, the unprocessed-requests refer to requests the corresponding contents to which have been not returned back to the client terminals 1-1 to 1-i although the requests had been already made from the client terminals 1-1 to 1-i.

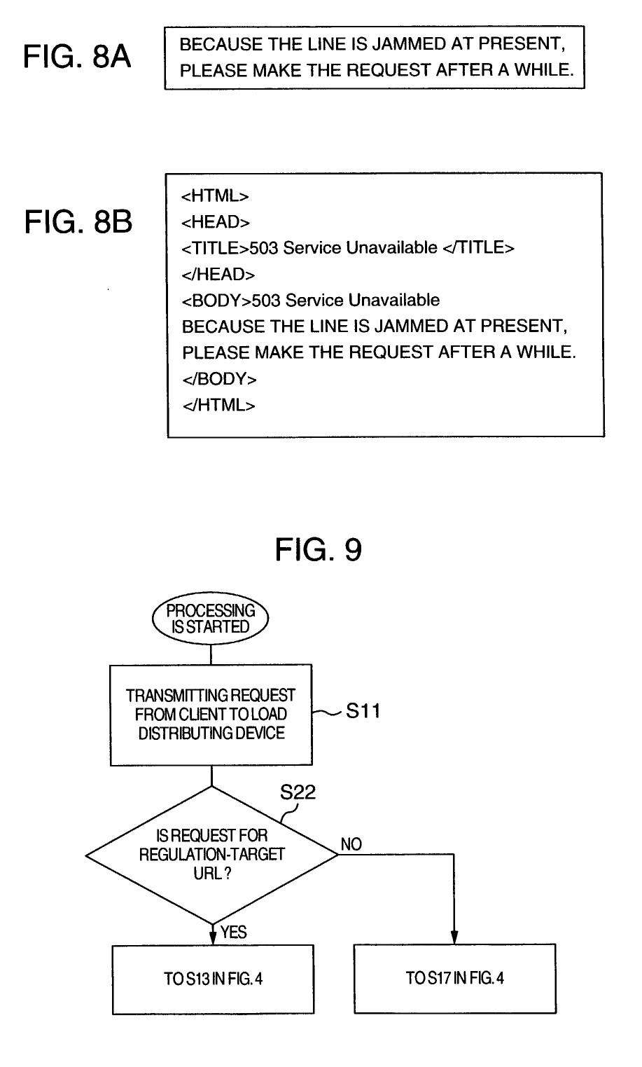

In the judgement processing at the step S12, if the unprocessed-requests number has exceeded the threshold value set in advance (“Yes”), at a step S13, the load distributing device 22 transmits the request from the client terminal 1 to the request regulating device 23. At a step S14, the request regulating device 23 acquires, from the message creation processing unit 45 therein, a regulating message content illustrated in FIG. 8A and saying, for example, “Because the line is jammed at present, please make the request after a while.” At a step S15, the request regulating device 23 creates regulating contents as illustrated in FIG. 8B, using the regulating message content. At a step S16, the request regulating device 23 transmits the regulating contents to the client terminal 1 via the load distributing device 22. Transmitting the regulating contents makes it possible to make the client suppress the request.

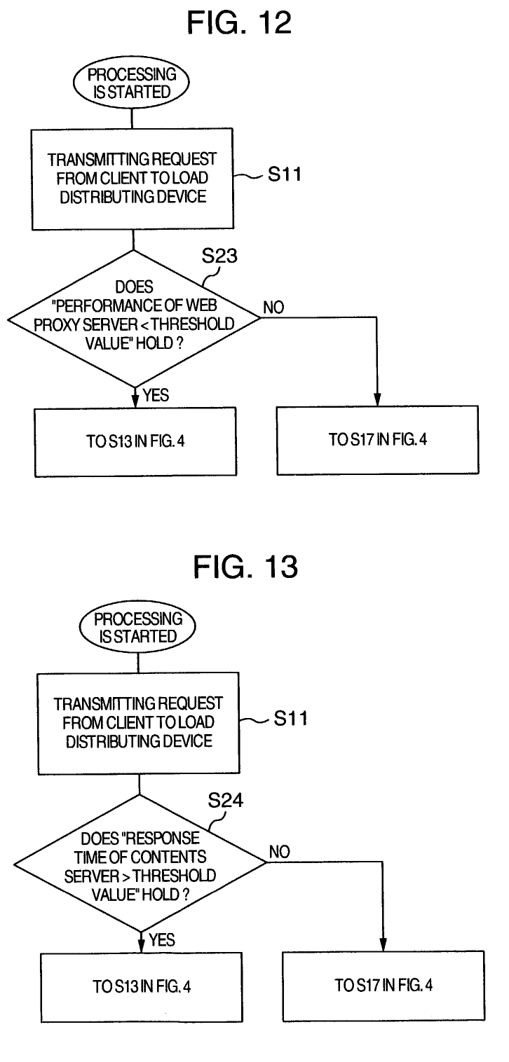

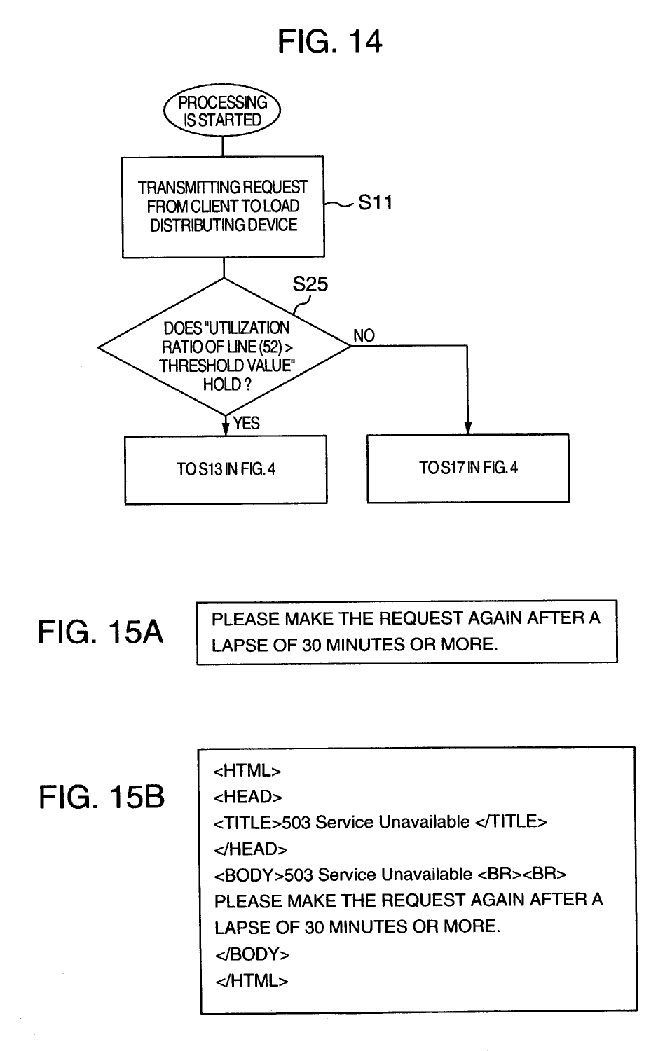

Meanwhile, if the judgement at the step S12 is “No”, at a step S17, the load distributing device 22 transmits the request to a Web proxy server 24 of the distribution destination. At a step S18, the Web proxy server 24 to which the request has been distributed confirms whether or not the contents corresponding to the request hit the cache 240 of its own. If the contents have hit the cache, at a step S19, the requested contents are transmitted to the client terminal 1 that had requested the contents. This suppresses the congestion on the communications line (52) between the data relaying device 21 and the contents servers 3-1 to 3-j. Incidentally, the load distributing device 22 is supposed to make the judgement in the judgement processing at the step S12 in FIG. 4 and FIG. 5. The following modification, however, may be performed here: The load distributing device 22 leaves the judgement to the request regulating device 23 and, based on a judgement result from the request regulating device 23, the load distributing device 22 suppresses the request transmission. This modification is also applicable to a step S22 in FIG. 9, a step S23 in FIG. 12, a step S24 in FIG. 13, and a step S25 in FIG. 14, all of which will be explained later.

On the other hand, if the contents have not hit the cache, at a step S20, the Web proxy server 24 to which the request has been distributed transmits the request to the contents server 3 of the request destination. At a step S21, the contents server 3 acquires the contents corresponding to the received request, then transmitting the contents to the client terminal 1. At this time, by way of the Web proxy server 24 to which the request has been distributed, the transmitted contents are temporarily stored into the cache 240 associated therewith.

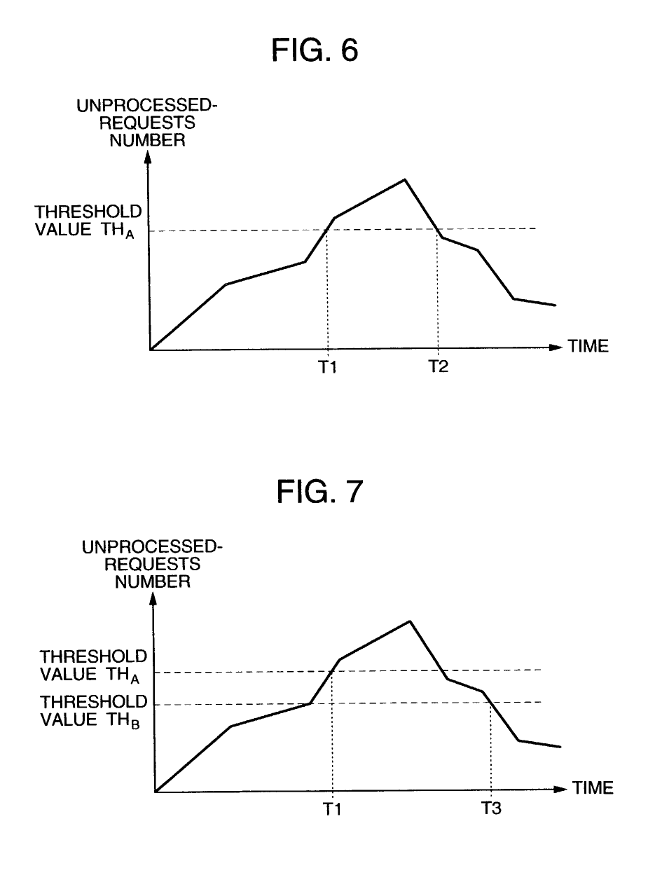

FIG. 6 is a diagram for illustrating a 1st judgement criterion for judging whether or not the unprocessed-requests number at the step S12 has exceeded the threshold value. The longitudinal axis denotes the unprocessed-requests number, and the transverse axis denotes time. The unprocessed-requests number since the starting of the contents requests generally increases with time, and begins to decrease at a point-in-time. The threshold value TH_{A} is a numerical value set in advance, and thus can be modified by the system manager, for example. At a time T1at which, of the requests from the client terminals 1-1 to 1-i, the unprocessed-requests number has exceeded the threshold value TH_{A}, the load distributing device 22 stops the request transmission to the Web proxy servers 24-1 to 24-n which the device 22 has continued until then, transmitting the requests to the request regulating device 23 instead.

Also, at a time T2 at which the unprocessed requests number has become smaller than the threshold value TH_{A}, the load distributing device 22 stops the request transmission to the request regulating device 23, transmitting the requests to the Web proxy servers 24-1 to 24-n instead.

FIG. 7 is a diagram for illustrating a 2nd judgement criterion for judging whether or not the unprocessed-requests number at the step S12 has exceeded threshold values. The threshold value TH_{A} and the threshold value TH_{B} are numerical values set in advance, and thus can be modified by the system manager, for example. At the time T1 at which, of the requests from the client terminals 1-1 to 1-i, the unprocessed-requests number has exceeded the threshold value TH_{A}, the load distributing device 22 stops the request transmission to the Web proxy servers 24-1 to 24-n which the device 22 has continued until then, transmitting the requests to the request regulating device 23 instead. At a time T3 at which the unprocessed-requests number has become smaller than the threshold value TH_{B}, the load distributing device 22 stops the request transmission to the request regulating device 23, transmitting the requests to the Web proxy servers 24-1 to 24-n instead. In this way, the setting of the plurality of threshold values, i.e., causing the threshold value to have hysteresis characteristics, makes it possible to stabilize the system.

Namely, in the case where there exists only the one type of threshold value (i.e., FIG. 6), when the unprocessed-requests number goes up and down the threshold value TH_{A}, there arrears a possibility that the destination of the request transmission from the load distributing device 22 is frequently switched between the request regulating device 23 and the Web proxy servers 24-1 to 24-n. The setting of the plurality of threshold values, however, makes it unnecessary to frequently switch the connection between the request regulating device 23 and the Web proxy servers 24-1 to 24-n, thereby allowing the offering of the stabilized system.

As described earlier, the message creation processing unit 45 creates the regulating message content illustrated in FIG. 8A and saying “Because the line is jammed at present, please make the request after a while.” FIG. 8B illustrates the description example of the above-described regulating contents. Rewriting the content of <BODY> can modify the message content.

As having been described so far, the congestion controlling system according to the embodiment of the present invention makes it possible to suppress the congestion between the client terminals 1-1 to 1-i and the contents servers 3-1 to 3-j, thereby allowing an effective offering of the contents providing service.

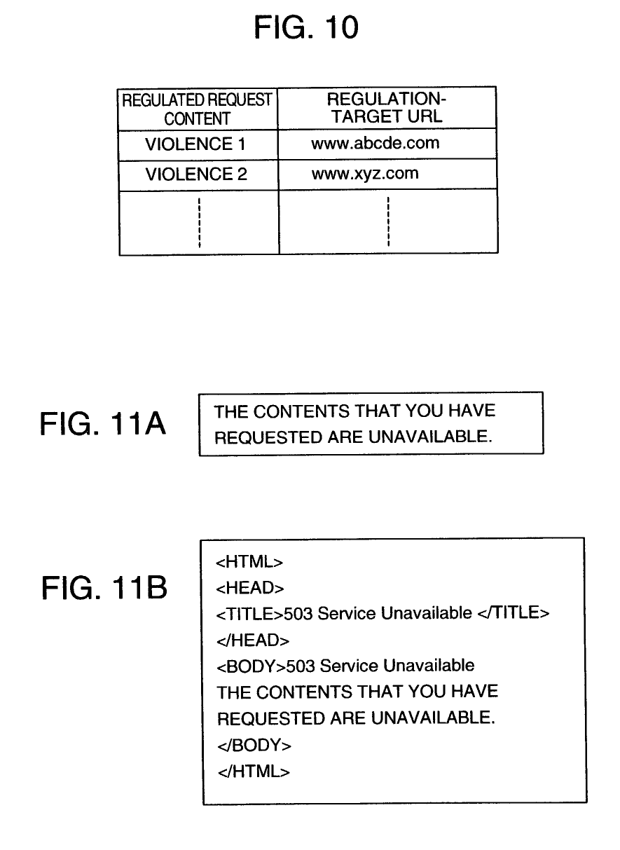

Next, referring to the FIG. 9 and FIG. 10, the explanation will be given below concerning a congestion controlling system according to a 1st modified example of the embodiment of the present invention.

FIG. 9 is a flowchart diagram for showing a congestion control technology according to the 1st modified example of the embodiment of the present invention. In the congestion control technology according to the 1st modified example, a requested URL is defined and employed as the judgement criterion.

The processing at a step S11 is basically the same as the processing at the step S11 illustrated in FIG. 4. Namely, at the step S11, a client terminal 1 transmits a request to the load distributing device 22. At a step S22, the load distributing device 22 checks whether the contents of a URL that the client terminal 1 has requested is of a content that is proper or improper for the transmission.

The judgement as to whether the content is proper or not can be made by, for example, making reference to the storage device 22-4 (FIG. 2A) provided within the load distributing device 22 and storing regulation-targets. Otherwise, the load distributing device 22 can make the judgement by making an inquiry of the browsing regulating device 26 (FIG. 1) provided outside the device 22. The storage device within the load distributing device 22 or a storage device within the browsing regulating device 26 includes a database as illustrated in FIG. 10 where the regulated request content and the regulation-target URLs are caused to correspond to each other. Moreover, the load distributing device 22 or the browsing regulating device 26 has a judgement processing unit for making a comparison between a requested URL and the content in the database corresponding to the URL so as to make a judgement as to whether the transmission of the contents included in the URL is proper or not. In preparation for the case where the browsing regulating device 26 make the judgement, the device 26 includes a communications processing unit for performing the communications processing with the load distributing device 22. Incidentally, the regulation-target URLs illustrated in FIG. 10 are for the mere presentation of examples, and thus there is no intention of indicating an existing specific URL.

At the step S22, if the contents of the requested URL are of the request for a regulation target URL, the processing goes to the step S13 illustrated in FIG. 4. At the step S13, the load distributing device 22 transmits the request from the client terminal 1 to the request regulating device 23. Hereinafter, basically the same processings as those in FIG. 4 will be performed. Incidentally, in the processings equivalent to those at the steps S14 and S15 in FIG. 4, the request regulating device (server) 23 acquires a regulating message content illustrated in, for example, FIG. 11A and saying “The contents that you have requested are unavailable.”, then creating regulating contents as illustrated in FIG. 11B with the use of this regulating message content. This allows the user, who has made the access from the client terminal 1, to know the reason why the user cannot acquire the contents, thereby permitting the user to stop the access rather earlier.

Meanwhile, at the step S22, if the contents of the requested URL are not of the request for the regulation-target URL, as illustrated in FIG. 9, the processing goes to the step S17 (FIG. 4). At the step S17, the load distributing device 22 transmits the request to a Web proxy server 24 to which the request has been distributed. Hereinafter, basically the same processings as those in FIG. 4 will be performed.

Next, referring to the FIG. 12, the explanation will be given below concerning a congestion controlling system according to a 2nd modified example of the embodiment of the present invention.

FIG. 12 is a flowchart diagram for showing a congestion control technology according to the 2nd modified example of the embodiment of the present invention. In the congestion control technology according to the 2nd modified example, the performance of the Web proxy server is defined and employed as the judgement criterion.

The processing at a step S11 is basically the same as the processing at the step S11 in FIG. 4. Next, at a step S23, the load distributing device 22 or the system managing device 25 judges whether or not the performance (e.g., the presence or absence of the operation, the CPU operation ratio, the vacant situation of the memory, the session number under the connection, and the like) of the Web proxy server 24 to which the request had been distributed has deteriorated more significantly than a threshold value. The presence or absence of the operation means whether or not the server is in an actual operation. The CPU operation ratio means an operation ratio of the processor 32 within the Web proxy server 24. If the operation ratio exceeds, for example, 80%, the performance of the Web proxy server 24 is judged to have deteriorated. The vacant situation of the memory means a vacant situation of the memory related with the processor 32. The session number under the connection corresponds to the unprocessed-requests number.

At the step S23, if it is judged that the performance of the Web proxy server 24 to which the request had been distributed has deteriorated, the processing goes to the step S13 (FIG. 4). At the step S13, the load distributing device 22 transmits the request from the client terminal 1 to the request regulating device 23. Hereinafter, basically the same processings as those in FIG. 4 will be performed.

Meanwhile, at the step S23, if it is judged that the performance of the Web proxy server 24 to which the request had been distributed has not deteriorated, the processing goes to the step S17 (FIG. 4). At the step S17, the load distributing device 22 transmits the request to the Web proxy server 24 to which the request had been distributed. Hereinafter, basically the same processings as those in FIG. 4 will be performed.

Next, referring to the FIG. 13, the explanation will be given below concerning a congestion controlling system according to a 3rd modified example of the embodiment of the present invention.

FIG. 13 is a flowchart diagram for showing a congestion control technology according to the 3rd modified example of the embodiment of the present invention. In the congestion control technology according to the 3rd modified example, the response time of the contents server is defined and employed as the judgement criterion.

FIG. 13 is the flowchart diagram for showing a congestion control method according to the 3rd modified example. The processing at a step S11 is basically the same as the processing at the step S11 in FIG. 4. Next, at a step S24, the load distributing device 22 or the system managing device 25 judges whether or not the response time of the contents server 3 of the request destination has exceeded a threshold value. As the threshold value of the response time, substantially 1 minute is preferable, for example. At the step S24, if it is judged that the response time of the contents server 3 has exceeded the threshold value, at the step S13 (FIG. 4), the load distributing device 22 transmits the request from the client terminal 1 to the request regulating device 23. Hereinafter, basically the same processings as those in FIG. 4 will be performed.

Meanwhile, at the step S24, if it is judged that the response time of the contents server 3 of the request destination has not exceeded the threshold value, the processing goes to the step S17 (FIG. 4). At the step S17, the load distributing device 22 transmits the request to the Web proxy server 24. Hereinafter, basically the same processings as those in FIG. 4 will be performed.

Next, referring to the FIG. 14, the explanation will be given below concerning a congestion controlling system according to a 4th modified example of the embodiment of the present invention.

FIG. 14 is a flowchart diagram for showing a congestion control technology according to the 4th modified example of the embodiment of the present invention. In the congestion control technology according to the 4th modified example, the line utilization ratio is defined and employed as the judgement criterion.

FIG. 14 is the flowchart diagram for showing a congestion control method where the line utilization ratio is defined and employed as the judgement criterion. The processing at a step S11 is basically the same as the processing at the step S11 in FIG. 4. Next, at a step S25, the load distributing device 22 or the system managing device 25 measures a utilization ratio of the communications line (52) between the data relaying device 21 and the contents server 3 of the request destination, thereby judging whether or not the line utilization ratio has exceeded a threshold value TH. If it is judged that the line utilization ratio has exceeded the threshold value TH, e.g., 90%, the processing goes to the step S13 (FIG. 4). At the step S13, the load distributing device 22 transmits the request from the client terminal 1 to the request regulating device 23. Hereinafter, basically the same processings as those in FIG. 4 will be performed. Meanwhile, at the step S25, if it is judged that the line utilization ratio has not exceeded the threshold value TH, the processing goes to the step S17. At the step S17, the load distributing device 22 transmits the request to the Web proxy server 24 to which the request had been distributed. Hereinafter, basically the same processings as those in FIG. 4 will be performed.

As having been explained so far, when performing the request regulation, the conditions at such steps as S12, S22, S23, S24, and S25 can be defined and employed as the judgement criterion for the request regulation. In addition, it is possible to determine the judgement criterion not only by selecting a single condition from these conditions, but by combining some of these conditions arbitrarily.

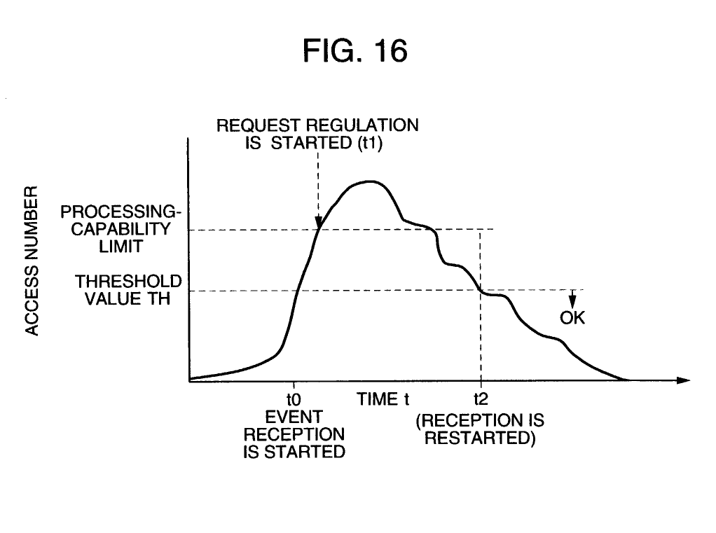

Next, referring to the FIG. 16, the explanation will be given below concerning a statistical information processing for predicting whether or not the request regulation will be able to be removed. FIG. 16 is a diagram for illustrating a time variation example in the access number to an event.

As illustrated in FIG. 16, in the case of the popular event, the access number increases steeply from a reception starting time t₀. At a time t₁, the accesses exceed the limit of the processing capability. From this time t₁ on, the request regulation is started. In the case of defining the limit of the processing capability to be 100%, a value smaller than 100%, e.g., a value of 80%, is determined as the predetermined threshold value TH of the access number. A time at which the access number has decreased and becomes equal to this threshold value TH is defined to be t₂. At the time t₂, the reception of the accesses is restarted. In this way, performing the request regulation in correspondence with the access number of the requests makes it possible to control the congestion. Incidentally, depending on the time variation in the access number, the threshold value can be changed as required.

Also, a time at which a predetermined time, e.g., 30 minutes or so, has elapsed from the time t₁may be defined as the reception restarting time t₂.

Incidentally, the request regulation is performed by selecting any one of the conditions at such steps as S12, S22, S23, S24, and S25, or by combining some of the conditions. Based on a statistical information processing function set up in the system managing device 25 or outside the system managing device, if it is predicted that the request regulation will be able to be removed, e.g., 30 minutes after, the request regulating device 23 can transmit, to the client terminal 1 that had transmitted the request, contents saying, for example, “Please make the request again after a lapse of 30 minutes or more.” as is illustrated in FIG. 15B.

It should be further understood by those skilled in the art that the foregoing description has been made on embodiments of the invention and that various changes and modifications may be made in the invention without departing from the spirit of the invention and the scope of the appended claims.

What is claimed is:

1. A congestion controlling device connected to a plurality of client terminals and a plurality of contents servers via communications lines, said plurality of client terminals being capable of making requests for acquisitions of information and displaying said information corresponding to said requests, said plurality of contents servers making responses to said requests so as to transmit, to said client terminals, said information corresponding to said requests, said congestion controlling device, comprising:
a data relaying device connected to said plurality of client terminals and said plurality of contents servers via said communications lines so as to perform a relay of data there between;
a load distributing device connected to said data relaying device so as to suppress a load in said data relay processing performed by said data relaying device; and
a request regulating device connected to said load distributing device so as to transmit a message to said client terminals specified by said load distributing device,
wherein, when said data relaying device receives said requests from said plurality of client terminals that have made said requests for said acquisitions of said information, said load distributing device judges whether or not a situation of said relay processing has satisfied a predetermined condition, said load distributing device, if said situation has satisfied said predetermined condition, instructing said request regulating device to transmit a predetermined message to said client terminals that are transmission sources of said requests.

2. The congestion controlling device as claimed in claim 1, wherein, if it is judged that a number of unprocessed requests from said plurality of client terminals has exceeded a predetermined threshold value, said load distributing device instructs said request regulating device to transmit said predetermined message to an effect that said communications lines have been jammed.

3. The congestion controlling device as claimed in claim 1, wherein, if it is judged that a request destination of said requests made from said client terminals is a predetermined regulation-target destination, said load distributing device instructs said request regulating device to transmit said predetermined message to an effect that information at said request destination is unavailable.

4. The congestion controlling device as claimed in claim 1, wherein, if it is judged that a response time of said contents servers that are request destinations of said requests from said client terminals has exceeded a predetermined threshold value, said load distributing device instructs said request regulating device to transmit said predetermined message to an effect of asking said client terminals to make said requests again after a lapse of time.

5. The congestion controlling device as claimed in claim 1, wherein, if it is judged that a utilization ratio of said communications lines has exceeded a predetermined threshold value, said load distributing device instructs said request regulating device to transmit said predetermined message to an effect of asking said client terminals to make said requests again after a lapse of time.

6. The congestion controlling device as claimed in claim 1, further comprising a plurality of Web proxy servers for transmitting said requests to said contents servers of request destinations and transmitting said information from said contents servers to said client terminals of said request sources, wherein, if said condition has been not satisfied, said load distributing device distributes said requests into one of said plurality of Web proxy servers.

7. The congestion controlling device as claimed in claim 6, wherein each of said plurality of Web proxy servers includes a cache for temporarily storing said information from said contents servers, and, if said information corresponding to said requests has been temporarily stored in said cache included in said Web proxy server into which said requests have been distributed, said Web proxy server transmits, to said client terminals of said request sources, said information stored temporarily in said cache.

8. A congestion controlling device provided between a plurality of client terminals and a plurality of contents servers via communications lines, said plurality of client terminals being capable of making requests for acquisitions of information and displaying said information acquired in response to said requests, said plurality of contents servers making responses to said requests so as to transmit, to said client terminals, said information corresponding to said requests, said congestion controlling device, comprising:
a data relaying device made related with said plurality of client terminals and said plurality of contents servers so as to perform a relay there between;
a plurality of Web proxy servers including means for caching information when said information is acquired and means for transmitting said information to said client terminals;
a load distributing device made related with said data relaying device and said Web proxy servers so as to perform a distributing control over said requests from said data relaying device so that said requests will not be concentrated on a particular Web proxy server; and
request regulating means made related with said load distributing device so as to regulate said requests from said client terminals.

9. The congestion controlling device as claimed in claim 8, wherein, if a number of said requests from said client terminals has exceeded a predetermined numerical value, said request regulating means causes said load distributing device to suppress said request transmission to said contents servers or said Web proxy servers.

10. The congestion controlling device as claimed in claim 8, wherein, if a performance of said Web proxy servers has deteriorated more significantly than a predetermined performance, said request regulating means causes said load distributing device to suppress said request transmission to said contents servers or said Web proxy servers.

11. The congestion controlling device as claimed in claim 8, wherein, if a response time from said contents servers has exceeded a predetermined numerical value, said request regulating means causes said load distributing device to suppress said request transmission to said contents servers or said Web proxy servers.

12. The congestion controlling device as claimed in claim 8, wherein, if a utilization ratio of a transferring system between said congestion controlling and said contents servers has exceeded a predetermined numerical value, said request regulating means causes said load distributing device to suppress said request transmission to said contents servers or said Web proxy servers.

13. The congestion controlling device as claimed in claim 8, wherein, in substitution for said contents servers or said Web proxy servers, said request regulating means receives said requests to be transmitted to said contents servers or said Web proxy servers.

14. The congestion controlling device as claimed in claim 8, further comprising information notifying means that, if said load distributing device does not transmit said requests to said contents servers or said Web proxy servers, notifies said client terminals of a message to an effect that acceptances of said requests are impossible.

15. The congestion controlling device as claimed in claim 8, further comprising information notifying means for denying an acceptance of a predetermined request, and for notifying said client terminals of a message to an effect that said acceptance of said request is impossible.

16. The congestion controlling device as claimed in claim 14, further comprising message creating means that, if acceptances of said requests from said client terminals are denied, edits content of a message to be transmitted to said client terminals.

17. The congestion controlling device as claimed in claim 8, further comprising informing means for predicting a point-in-time at which to remove a request regulation in accordance with a time variation in a number of unprocessed requests, and for transmitting, from said request regulating means to said client terminals, information including said scheduled point-in-time at which to remove said request regulation.

18. A congestion controlling method in a communication system including a plurality of client terminals capable of making requests for acquisitions of information and displaying said information acquired in response to said requests, a plurality of contents servers for making responses to said requests so as to transmit, to said client terminals, said information corresponding to said requests, a data relaying device for performing a relay between said plurality of client terminals and said plurality of contents servers, a plurality of Web proxy servers including means for caching information when said information is acquired and means for transmitting said information to said client terminals, and a load distributing device for performing a distributing control over said requests from said data relaying device so that said requests will not be concentrated on a particular Web proxy server, said congestion controlling method, comprising the steps of:
(a) judging whether or not a situation of said data relay processing performed by said data relaying device has satisfied a predetermined condition; and
(b) suppressing said request transmission to said contents servers or said Web proxy servers if said predetermined condition has been satisfied.

19. The congestion controlling method as claimed in claim 18, wherein,
at said step (a), it is judged whether or not a number of said requests from said client terminals has exceeded a predetermined numerical value, and,
at said step (b), said request transmission to said contents servers or said Web proxy servers is suppressed if said number of said requests has exceeded said predetermined numerical value.

20. The congestion controlling method as claimed in claim 18, wherein,
at said step (a), a performance of said Web proxy servers is measured, and,
at said step (b), said request transmission to said contents servers or said Web proxy servers is suppressed if said performance of said Web proxy servers has deteriorated more significantly than a predetermined performance.

21. The congestion controlling method as claimed in claim 18, wherein,
at said step (a), a response time from said contents servers is measured, and,
at said step (b), said request transmission to said contents servers or said Web proxy servers is suppressed if said response time from said contents servers has exceeded a predetermined numerical value.

22. The congestion controlling method as claimed in claim 18, wherein,
at said step (a), a utilization ratio of a transferring system to said contents servers is measured, and,
at said step (b), said request transmission to said contents servers or said Web proxy servers is suppressed if said utilization ratio of said transferring system has exceeded a predetermined numerical value.

23. A congestion controlling system, comprising:
a plurality of client terminals capable of making requests for acquisitions of information and displaying said information acquired in response to said requests;
a plurality of contents servers for making responses to said requests so as to transmit, to said client terminals, said information corresponding to said requests; and
a congestion controlling device provided between said plurality of client terminals and said plurality of contents servers via communications lines, said congestion controlling device including:
a data relaying device made related with said plurality of client terminals and said plurality of contents servers so as to perform a relay there between;
a plurality of Web proxy servers including means for caching information when said information is acquired and means for transmitting said information to said client terminals;
a load distributing device made related with said data relaying device and said Web proxy servers so as to perform a distributing control over said requests from said data relaying device so that said requests will not be concentrated on a particular Web proxy server; and
request regulating means made related with said load distributing device so as to regulate said requests from said client terminals.
